(19) United States
(12) Patent Application Publication
(10) Pub. No.: US 2026/0165285 A1
(43) Pub. Date: Jun. 18, 2026

(54) PET TOILET DEVICE AND PET DEFECATION DETERMINATION METHOD

(71) Applicant: Lu-Ting HSU, New Taipei City (TW)

(72) Inventor: Lu-Ting HSU, New Taipei City (TW)

(21) Appl. No.: 19/330,361

(22) Filed: Sep. 16, 2025

(30) Foreign Application Priority Data
Dec. 12, 2024 (TW) 113148456

(51) Int. Cl. A01K 1/01; A01K 29/00

(52) U.S. Cl. CPC A01K 1/0107; A01K 29/007

(57) ABSTRACT

The pet toilet device comprises a storage space, a plurality of load cells, a standing platform and a monitoring device. The storage space is used to accommodate pet excrement. The load cells are arranged on the upper surface of the storage space. The standing platform is placed on the load cells. The standing platform is configured to allow the pet to defecate. The load cells respectively measure the weight applied on the standing platform to generate a plurality of corresponding weight values. The monitoring device coupled to the load cells receives the weight values to generate a position of the center of gravity, and determines whether the pet is in the defecation state according to the duration of the position of the center of gravity within the range of the center of gravity stability frame.

### RELATED APPLICATIONS

This application claims priority to Taiwan Application Serial Number 113148456, filed Dec. 12, 2024, which is herein incorporated by reference.

### BACKGROUND

### Field of Invention

The present invention relates to a toilet device, and in particular to a pet toilet device and a pet defecation determination method.

### Description of Related Art

In the process of raising pets, if cats and dogs urinate and excrete anywhere, it will not only affect the cleanliness and hygiene of the home environment, but also easily cause health hazards to both the pets and their owners. Therefore, owners often put newspapers on the floor or use cat litter boxes for pets to excrete. Regardless of which method is used, after each pet excretion, the owner still needs to manually collect the pet's excrement and clean the excretion area or regularly replace the cat litter to prevent odor or infectious diseases. This is a heavy and tiring job for the owner.

Therefore, there is a need for a pet toilet device that can help owners collect pet excrement and clean it after the pet defecates.

### SUMMARY

The foregoing presents a simplified summary of the disclosure in order to provide a basic understanding to the reader. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

One objective of the present disclosure is to provide a pet toilet device. The pet toilet device comprises a storage space, a plurality of load cells, a standing platform and a monitoring device. The storage space is used to accommodate pet excrement. The load cells are arranged on the upper surface of the storage space. The standing platform is placed on the load cells. The standing platform is configured to support a pet during a defecation-related activity. The load cells respectively measure the weight applied on the standing platform to generate a plurality of corresponding weight values. The monitoring device coupled to the load cells receives the weight values to generate a position of the center of gravity, and determines whether the pet is in the defecation state according to a duration during which the position of the center of gravity remains within a center of gravity stability frame.

In some embodiments, the upper surface of the storage space further has a first opening, and the load cells are distributed around the first opening.

In some embodiments, the standing platform has a second opening positioned opposite to the first opening, and the pet's excrement falls into the storage space through the first opening and the second opening.

In some embodiments, the monitoring device defines a center of gravity stability frame by expanding outward from the center of gravity position.

In some embodiments, the monitoring device generates the position of the center of gravity according to the weight values and the positions of the load cells arranged at the upper surface of the storage space.

In some embodiments, when an updated position of the center of gravity touches the frame of the center of gravity stability frame, the monitoring device further moves the center of gravity stability frame according to the moving direction of the updated position of the center of gravity.

In some embodiments, when the duration is greater than a threshold value, the monitoring device determines that the pet is in the defecation state.

In some embodiments, when the duration is greater than a threshold value, the monitoring device further starts a cleaning program to clean the pet toilet device.

Another object of the present invention is to provide a pet defecation determination method, comprising: calculating a center of gravity position of a pet based on weight values measured at a plurality of sensor positions on a pet toilet device; defining a center of gravity stability frame according to the outward expansion distance of the position of the center of gravity; determining whether an updated pet's position of the center of gravity is in the center of gravity stability frame or not; when the updated pet's position of the center of gravity is in the center of gravity stability frame, calculating the duration of the updated pet's position of the center of gravity in the center of gravity stability frame; comparing the duration with a threshold value; and when the duration is greater than the threshold value, determining that the pet is defecating.

In some embodiments, when the updated pet's position of the center of gravity touches the edge of the center of gravity stability frame, the pet defecation determination method further comprises moving the center of gravity stability frame according to the moving direction of the updated pet's position of the center of gravity.

In some embodiments, the pet defecation determination method further comprises starting a cleaning program to clean the pet toilet device when the duration is greater than the threshold value.

In some embodiments, the pet defecation determination method further comprises using a plurality of load cells, which are arranged at predetermined positions on the pet toilet device, to measure the weight values applied by the pet.

In some embodiments, the pet defecation determination method further comprises calculating the position of the center of gravity of the pet based on the measured weight values and the corresponding spatial positions of the plurality of load cells.

In some embodiments, the pet defecation determination method further comprises setting an idle state time threshold value.

In some embodiments, the pet defecation determination method further comprises calculating a duration during which the pet is absent from the pet toilet device.

In some embodiments, the pet defecation determination method further comprises controlling the load cells to execute a zeroing procedure when the calculated duration exceeds the idle state time threshold value.

The pet toilet device and the pet defecation determination method of the present application can monitor and determine whether the pet is in the defecation state or not and collect pet excrement. Moreover, the pet toilet device automatically performs a clean process to clean the pet toilet device in real time after the defecation is completed. Therefore, it is not necessary for the owner to manually collect the pet's excrement and clean the defecation area after each pet defecation, which saves a lot of time.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a side view of a pet toilet device according to a preferred embodiment of the present invention.

FIG. 2 is a top view of the storage space of a pet toilet device according to a preferred embodiment of the present invention.

FIG. 3 is a schematic diagram for a control device of a pet toilet device according to a preferred embodiment of the present invention.

FIG. 4A is a schematic diagram for calculating the position of the center of gravity according to a preferred embodiment of the present invention.

FIG. 4B is a schematic diagram for defining a center of gravity stability frame according to a preferred embodiment of the present invention.

FIG. 4C is a schematic diagram for redefining a center of gravity stability frame according to a preferred embodiment of the present invention.

FIG. 4D is a schematic diagram for determining that a pet is defecating according to a preferred embodiment of the present invention.

FIG. 5 is a flow chart of a pet defecation determination method according to a preferred embodiment of the present invention.

### DESCRIPTION OF THE EMBODIMENTS

To make the contents of the present disclosure more thorough and complete, the following illustrative description is given with regard to the implementation aspects and embodiments of the present disclosure, which is not intended to limit the scope of the present disclosure. The features of the embodiments and the steps of the method and their sequences that constitute and implement the embodiments are described. However, other embodiments may be used to achieve the same or equivalent functions and step sequences.

Unless otherwise defined herein, scientific and technical terminologies employed in the present disclosure shall have the meanings that are commonly understood and used by one of ordinary skill in the art. Unless otherwise required by context, it will be understood that singular terms shall include plural forms of the same and plural terms shall include the singular. Specifically, as used herein and in the claims, the singular forms “a” and “an” include the plural reference unless the context clearly indicates otherwise.

Typically, owners often put newspapers on the floor or use cat litter boxes for pets to excrete. Regardless of which method is used, after each pet excretion, the owner still needs to manually collect the pet's excrement and clean the excretion area or regularly replace the cat litter to prevent odor or infectious diseases. This is a heavy and tiring job for the owner. Therefore, the present invention provides a pet toilet device that can monitor whether the pet is in a defecation state or not and collect pet excrement. Moreover, the pet toilet device automatically performs a clean process to clean the pet toilet device in real time after the defecation is completed. Accordingly, it is not necessary for the owner to manually collect the pet's excrement and clean the defecation area after each pet defecation.

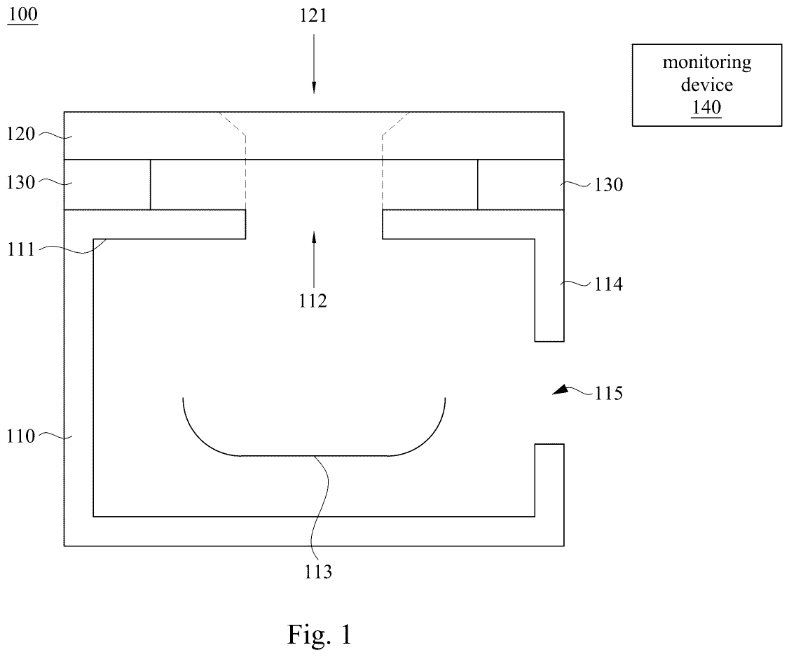

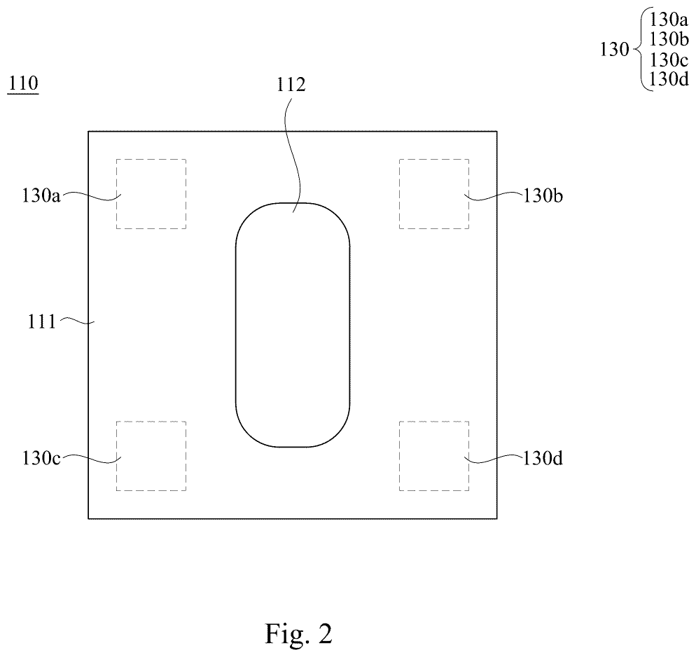

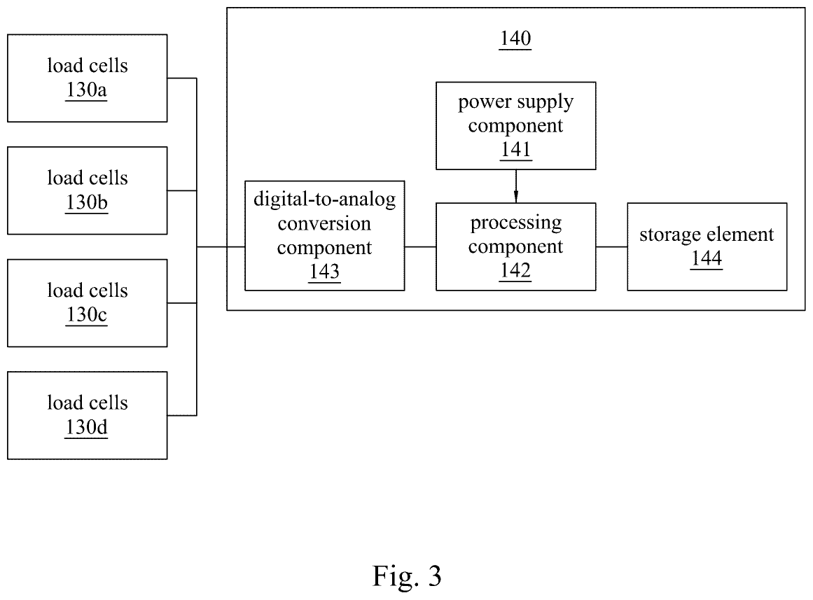

FIG. 1 shows a side view of a pet toilet device according to a preferred embodiment of the present invention. FIG. 2 shows a top view of the storage space of a pet toilet device according to a preferred embodiment of the present invention. FIG. 3 shows a schematic diagram for a control device of a pet toilet device according to a preferred embodiment of the present invention. In some embodiments, the pet toilet device 100 is used for domestic animals, such as cats, dogs and other pets when defecating. However, it should be noted that the pet toilet device 100 is not limited to the above-mentioned pets. The pet toilet device 100 is also used for other animals.

As illustrated in FIGS. 1 to 3, the pet toilet device 100 includes a storage space 110, a standing platform 120, and a plurality of load cells 130. In addition, the pet toilet device 100 has a monitoring device 140. The monitoring device 140 monitors whether the pet is in a defecation state or not. After the pet has finished defecation, the monitoring device 140 controls the pet toilet device 100 to perform a clean process to clean the pet toilet device 100. In some embodiments, the storage space 110 can be implemented by a storage bucket. In other words, the storage space 110 is not limited to any shape or form. As long as it can accommodate pet excrement, it can be used as the storage space 110. For example, a ready-made recess or toilet can be used as the storage space 110.

In some embodiments, if the storage space 110 is implemented by a storage space, the interior of the storage space 110 becomes hollow and an opening 112 is provided on the upper surface 111. In some embodiments, an excrement container 113 for carrying pet excrement is provided inside the storage space 110. The excrement container 113 can be arranged in a manner of sliding into the storage space 110, but the present invention is not limited thereto. In some embodiments, an opening 115 can be formed on the side surface 114 of the storage space 110. The excrement container 113 can be slidably inserted into the storage space 110 from the opening 115, and the excrement container 113 can also be pulled out through the opening 115 to clean up the pet excrement that falls on the excrement container 113. In other embodiments, other openings can also be designed to clean up the pet excrement that falls on the excrement container 113.

The standing platform 120 is arranged above the storage space 110. In some embodiments, the standing platform 120 is a platform for carrying pets and allowing the pets to excrete in a squatting or standing position. The standing platform 120 is provided with an opening 121, which is positioned opposite to the opening 112 on the upper surface 111 of the storage space 110. Therefore, when a pet excretes above the standing platform 120, the pet's excrement can pass through the opening 121 of the standing platform 120, and fall into the excrement container 113 inside the storage space 110 through the opening 112 on the upper surface 111 of the storage space 110 positioned opposite to the opening 121 of the standing platform 120. In some embodiments, the opening 121 on the standing platform 120 can be designed with an inclined edge to guide the pet's excrement to pass through the opening 121 and fall into the excrement container 113.

A plurality of load cells 130 are arranged on the upper surface 111 of the storage space 110 and around the opening 112. The upper part of the plurality of load cells 130 contacts the standing platform 120 and is pressed by the standing platform 120. The pressing force is converted into an electrical signal by the load cells 130 to output to detect the weight at the corresponding position of the standing platform 120. In some embodiments, the plurality of load cells 130 include four load cells 130, namely, load cells 130a, 130b, 130c and 130d, which are respectively installed at the four corners of the upper surface 111 of the storage space 110 and around the opening 112, as shown in FIG. 3. However, in other embodiments, the number of load cells is not limited to four, and may be more than four or less than four. In some embodiments, the load cell 130 is a force sensor, which may be a spring-type or piezoelectric component-type force sensor, a magnetostrictive force sensor, an electrostatic capacitance-type force sensor, a gyroscopic force sensor or a strain gauge-type force sensor, but the present invention is not limited to the above. In some embodiments, when the load cell 130 is a strain sensor, the internal parts of the load cell 130 are deformed due to the weight. Accordingly, the deformation of the internal parts is converted into an electrical signal by the strain sensor. The strain sensor measures the weight by means of the electrical signal.

In some embodiments, when the pet jumps onto the standing platform 120, the pet's behavior on the standing platform 120 can be summarized into the following types: (1) The standing platform 120 is only used as a springboard and the pet is just passing by. (2) Before defecation, the pet observes and circles to find a suitable position and posture for defecation. (3) The pet is ready to defecate and stays still to defecate. (4) The pet is not ready to defecate and jumps off the standing platform 120. The monitoring device 140 of the pet toilet device 100 monitors the movement of the pet on the standing platform 120 to determine whether the pet is ready to defecate. That is, the monitoring device 140 monitors whether the pet's behavior on the standing platform 120 is the above-mentioned type (3), the pet is ready to defecate and stays still to defecate.

As shown in FIG. 3, the monitoring device 140 includes a power supply component 141, a processing component 142, a digital-to-analog conversion component 143, and a storage element 144. In some embodiments, the power supply component 141 is used to provide power to the processing component 142, the digital-to-analog conversion component 143, and the storage element 144 of the monitoring device 140. In addition, the power supply component 141 is also used to supply power to the load cells 130a, 130b, 130c, and 130d, so that the load cells 130a, 130b, 130c, and 130d perform weight measurement. In some embodiments, the power supply component 141 is a battery. In some embodiments, the storage element 144 can be integrated into the processing component 142.

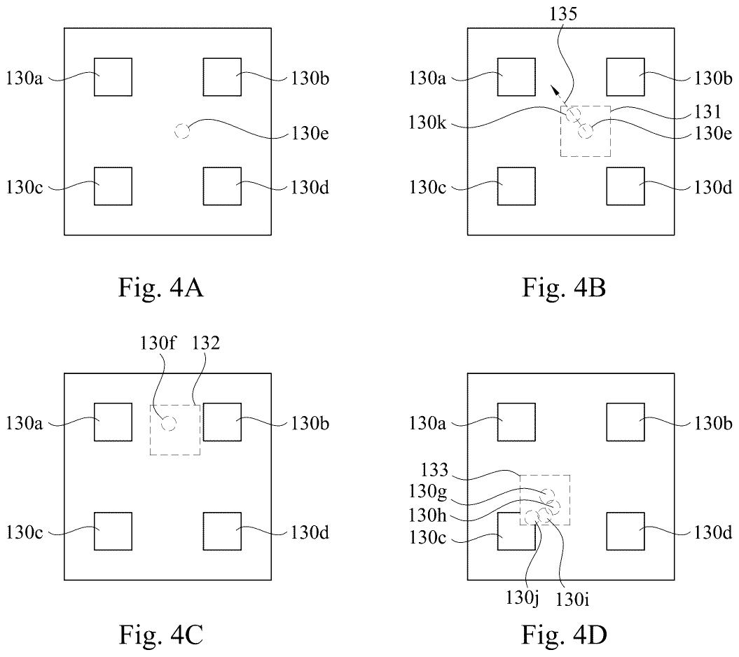

FIG. 4A illustrates a schematic diagram for calculating the position of the center of gravity according to a preferred embodiment of the present invention. After the load cells 130a, 130b, 130c and 130d perform weight measurement to get the weight values, the digital-to-analog conversion component 143 receives the weight values measured by the load cells 130a, 130b, 130c and 130d, respectively, and converts the weight values in analog form into weight values in digital form to transmit them to the processing component 142. As shown in FIG. 4A, the processing component 142 is used to calculate the position of the center of gravity 130e according to the weight values measured by the load cells 130a, 130b, 130c and 130d and the positions of the load cells 130a, 130b, 130c and 130d, so as to determine whether the pet is on the standing platform 120 and whether the pet has been motionless on the standing platform 120 for a period of time. In some embodiments, the positions where the load components 130a, 130b, 130c and 130d are set on the upper surface 111 of the storage space 110 are given positions. It is a known technology to calculate the position of the center of gravity using the position of the load cells 130a, 130b, 130c and 130d and the corresponding measured weight values, which will not be repeated here.

FIG. 4B illustrates a schematic diagram for defining the center of gravity stability frame according to a preferred embodiment of the present invention. Because the pet may move slightly during defecation, these movements will cause the center of gravity to move. In order to allow the processing component 142 to determine the above-mentioned center of gravity movement as the pet being stationary on the standing platform 120, as shown in FIG. 4B, after calculating the position of the center of gravity 130e, the center of gravity stability frame 131 will be defined according to the position of the center of gravity 130e. As long as the calculated position of the center of gravity falls within the center of gravity stabilization frame 131, the processing component 142 will determine that the pet is maintaining a stationary state on the standing platform 120. In some embodiments, the center of gravity stabilization frame 131 is formed by expanding the position of the center of gravity 130e outward by a specific distance. The shape is not limited to the square shown in FIG. 4B. In other embodiments, the center of gravity stabilization frame 131 may be rectangular, circular, or other shapes. In some embodiments, the range of the center of gravity stabilization frame 131 may be changed according to the type of pet being monitored.

FIG. 4C illustrates a schematic diagram for redefining the center of gravity stabilization frame according to a preferred embodiment of the present invention. In some embodiments, when the updated position of the center of gravity calculated after the pet moves again touches the frame edge of the center of gravity stabilization frame 131, the center of gravity stabilization frame 131 will move along the moving direction of the position of the center of gravity 130e. That is, the center of gravity stabilization frame 131 will move away from the original position and move to an updated position until the updated position of the center of gravity no longer touches the frame edge of the center of gravity stabilization frame 131. In some embodiments, as shown in FIG. 4B, after the position of the center of gravity 130e is calculated, the center of gravity stabilization frame 131 is defined according to the position of the center of gravity 130e. When the position of the center of gravity 130e changes to the position of the center of gravity 130k along the moving direction 135 and touches the frame edge of the center of gravity stabilization frame 131 due to the movement of the pet, the center of gravity stabilization frame 131 moves along the moving direction 135 of the position of the center of gravity 130k. That is, the center of gravity stabilization frame 131 will leave the original position shown in FIG. 4B and move to the updated position shown in FIG. 4C along the moving direction 135 of the position of the center of gravity 130k until the updated position of the center of gravity 130f no longer touches the frame edge of the center of gravity stabilization frame 132. At this time, the center of gravity stabilization frame 132 no longer moves and remains in a stable position. When the center of gravity stabilization frame 131 moves along the moving direction 135 of the position of the center of gravity 130k, the processing component 142 determines that the pet is not maintaining a motionless state on the standing platform 120.

FIG. 4D shows a schematic diagram for determining that a pet is defecating according to a preferred embodiment of the present invention. In some embodiments, when the position of the center of gravity no longer touches the frame edge of the center of gravity stabilization frame and the center of gravity stabilization frame no longer moves and remains in a stable position, the processing component 142 will begin to determine the duration of the pet's position of the center of gravity on the standing platform 120 remaining in the center of gravity stabilization frame. When the duration of the pet's position of the center of gravity remaining in the center of gravity stable frame reaches the defecation state time threshold, it is determined that the pet is defecating. As shown in FIG. 4D, when the position of the center of gravity no longer touches the frame edge of the center of gravity stabilization frame 133 and the center of gravity stabilization frame 133 no longer moves, the processing component 142 will begin to determine whether the subsequent positions of centers of gravity 130g, 130h, 130i, and 130j of the pet on the standing platform 120 do not touch the frame edge of the center of gravity stabilization frame 133 and whether the duration of the positions of centers of gravity 130g, 130h, 130i, and 130j remaining in the center of gravity stabilization frame 133. That is, if the subsequent all positions of centers of gravity 130g, 130h, 130i, and 130j do not touch the edge of the center of gravity stabilization frame 133, it means that the position of the center of gravity of the pet after pet moving all remain in this center of gravity stabilization frame 133. Accordingly, the processing component 142 will determine that the pet is maintaining a motionless state on the standing platform 120 and the processing component 142 will start to calculate a duration of the pet's position of the center of gravity remaining in the center of gravity stable frame 133. In some embodiments, a defecation state time threshold value can be set. In some embodiments, a defecation state time threshold may be set. When the duration of the position of the center of gravity remaining in the center of gravity stability frame 133 reaches the defecation state time threshold, the processing component 142 will determine that the pet is not only maintaining a motionless state on the standing platform 120, but is also in a defecation state. In some embodiments, if a subsequent position of the center of gravity of the pet touches the edge of the center of gravity stabilization frame 133 again within this defecation state time threshold value, the processing component 142 will determine that the pet is not in a defecation state. Accordingly, the processing component 142 recalculates the duration of the pet's position of the center of gravity remaining in the center of gravity stable frame 133 according to the center of gravity stable frame after the movement.

On the other hand, when the pet's center of gravity is within the center of gravity stabilization frame 133 for a duration exceeding the defecation state time threshold, the processing component 142 will determine that the pet has completed defecation if the pet's center of gravity calculated thereafter touches the edge of the center of gravity stabilization frame 133. At this time, the processing component 142 starts a cleaning program to clean the pet toilet device 100. In some embodiments, a water outlet can be set on the standing platform 120, and an external water source can be connected. After the processing component 142 determines that the pet has finished defecating, the processing component 142 controls the water outlet to discharge water to clean the standing platform 120. It is worth noting that the cleaning method of the present invention is not limited to the above.

In other embodiments, an idle state time threshold value may be set. When the duration of the pet not being on the toilet device is greater than the idle state time threshold value, the processing component 142 controls the load cells 130a, 130b, 130c and 130d to execute a zeroing procedure to ensure that the load cells 130a, 130b, 130c and 130d are at the measurement reference point. In some embodiments, when the pet toilet device 100 is started, each load cell 130a, 130b, 130c and 130d has an initial measurement value, that is, a measurement reference point, which is the weight value measured by the load cells 130a, 130b, 130c and 130d when the pet is not on the standing platform 120 of the pet toilet device 100. Therefore, when the weight value measured by the load cells 130a, 130b, 130c and 130d show that the weight of the pet is not included, that is, the pet has left the standing platform 120 of the pet toilet device 100, the processing component 142 calculates the duration of the pet leaving the standing platform 120 of the pet toilet device 100. When this duration is greater than the idle state time threshold value, the processing component 142 will control the load cells 130a, 130b, 130c and 130d to execute a zeroing procedure.

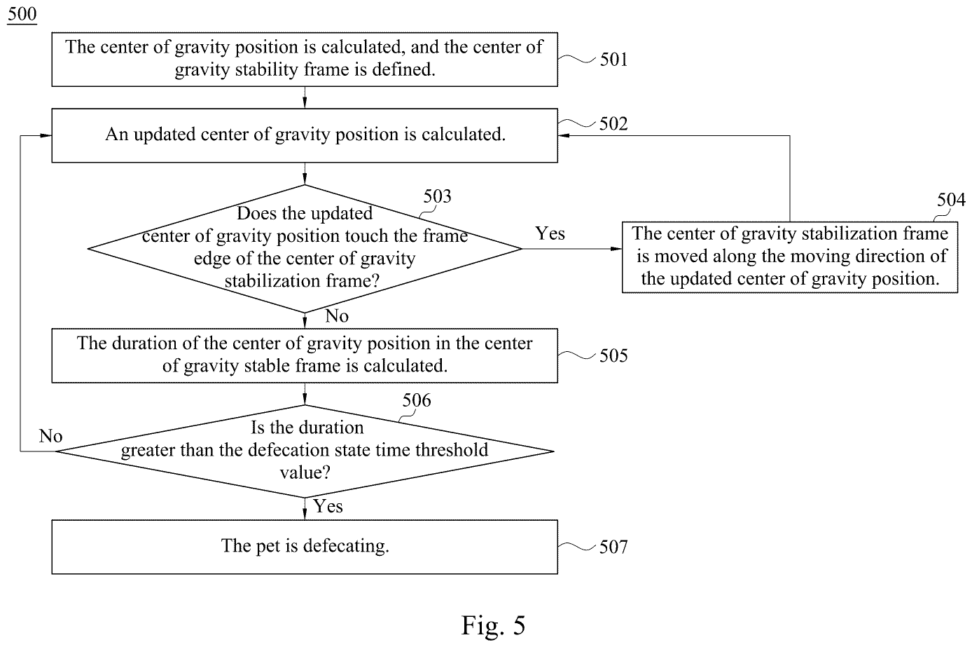

FIG. 5 is a flow chart of a pet defecation determination method according to a preferred embodiment of the present invention. In a preferred embodiment, the storage element 144 stores at least a plurality of computer-readable instructions. The processing component 142 is electrically coupled to the storage element 144 to access the computer-readable instructions from the storage element 144 and execute an application program of a pet defecation determination method to determine whether the pet has defecated. In a preferred embodiment, the storage element 144 is any storage device that can be used to store data, which can be, for example, but not limited to, a random access memory (RAM), a read-only memory (ROM), a flash memory, a hard disk, or other storage devices that can be used to store data. The pet defecation determination method 500 can apply the pet toilet device 100 shown in FIGS. 1 to 3 to determine the pet's defecation and automatically clean the pet toilet device 100, thereby saving a lot of time.

The pet defecation determination method 500 first calculates the position of the center of gravity to define the center of gravity stability frame in step 501. In some embodiments, the processing component 142 is used to calculate the position of the center of gravity 130e of the pet on the standing platform 120 according to the weight values measured by the load cells 130a, 130b, 130c and 130d and the positions of the load cells 130a, 130b, 130c and 130d. The processing component 142 defines the center of gravity stability frame 131 according to the position of the center of gravity 130e.

In step 502, an updated position of the center of gravity is calculated. In some embodiments, the processing component 142 continuously reads the weight values measured by the load cells 130a, 130b, 130c and 130d, and the positions of the load cells 130a, 130b, 130c and 130d to update the position of the center of gravity 130e of the pet on the standing platform 120.

In step 503, whether the updated position of the center of gravity touches the frame edge of the center of gravity stabilization frame is determined. In some embodiments, the processing component 142 determines whether the updated position of the center of gravity touches the frame edge of the center of gravity stabilization frame 131.

When the updated position of the center of gravity touches the frame edge of the center of gravity stabilization frame 131, step 504 is executed. In step 504, the center of gravity stabilization frame is moved along the moving direction of the position of the center of gravity. In some embodiments, as shown in FIG. 4B, when the position of the center of gravity 130e changes to the position of the center of gravity 130k along the moving direction 135 and touches the frame edge of the center of gravity stabilization frame 131 due to the movement of the pet, the center of gravity stabilization frame 131 moves along the moving direction 135 of the position of the center of gravity 130k. That is, the center of gravity stabilization frame 131 will leave the original position shown in FIG. 4B and move to the updated position shown in FIG. 4C along the moving direction 135 of the position of the center of gravity 130k.

Then, step 502 is executed again to calculate an updated position of the center of gravity. In some embodiments, the processing component 142 updates the position of the center of gravity 130e of the pet on the standing platform 120 according to the weight values measured by the load cells 130a, 130b, 130c and 130d and the positions of the load cells 130a, 130b, 130c and 130d. In step 503, it is determined again whether the updated position of the center of gravity touches the edge of the center of gravity stability frame.

On the contrary, when the updated position of the center of gravity does not touch the edge of the center of gravity stability frame 131, step 505 will be executed to start calculating the duration of the position of the center of gravity in the center of gravity stable frame. In some embodiments, when the updated position of the center of gravity does not touch the edge of the center of gravity stability frame 131, the processing component 142 will start calculating the duration of the position of the center of gravity in the center of gravity stable frame.

Then, in step 506, it is determined whether the duration is greater than the defecation state time threshold value. If the duration is greater than the defecation state time threshold value, step 507 is performed. In step 507, it is determined that the pet is defecating. In some embodiments, when the duration of the position of the center of gravity maintained in the center of gravity stable frame reaches a defecation state time threshold value, it is determined that the pet is defecating. Then, when the weight values calculated by the load cells 130a, 130b, 130c and 130d show that the weight of the pet is not included, it is determined that the pet has left the pet toilet device 100. Then, the processing component 142 starts a cleaning program to clean the pet toilet device 100.

On the contrary, when the duration is less than the defecation state time threshold value, step 502 is executed again to calculate the updated position of the center of gravity. In some embodiments, the processing component 142 updates the position of the center of gravity 130e of the pet on the standing platform 120 according to the weight values measured by the load cells 130a, 130b, 130c and 130d and the positions of the load cells 130a, 130b, 130c and 130d. In step 503, it is determined again whether the updated position of the center of gravity touches the edge of the center of gravity stability frame.

Accordingly, in the present application, the pet toilet device and the corresponding pet defecation determination method can monitor and determine whether the pet is in the defecation state or not and collect pet excrement. Moreover, the pet toilet device automatically performs a clean process to clean the pet toilet device in real time after the defecation is completed. Accordingly, it is not necessary for the owner to manually collect the pet's excrement and clean the defecation area after each pet defecation, thus saving a lot of time.

In addition, the above examples include sequential exemplary steps, but the steps do not have to be performed in the order shown. Performing the steps in different orders is within the scope of the present disclosure. Within the spirit and scope of the embodiments of the present disclosure, the steps may be added, replaced, changed in order, and/or omitted as appropriate.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pet toilet device, comprising:
a storage space for accommodating excrement of a pet;
a plurality of load cells arranged on an upper surface of the storage space;
a standing platform arranged on the plurality of load cells and configured to support a pet during a defecation-related activity, wherein the load cells respectively measure weight applied on the standing platform to generate a plurality of weight values; and
a monitoring device coupled to the load cells to receive the weight values and generate a position of the center of gravity, wherein the monitoring device determines whether the pet is in a defecation state according to a duration during which the position of the center of gravity remains within a center of gravity stability frame.

2. The pet toilet device as claimed in claim 1, wherein the upper surface of the storage space further comprises a first opening, and the plurality of load cells are distributed around the first opening.

3. The pet toilet device as claimed in claim 2, wherein the standing platform comprises a second opening positioned opposite to the first opening, and the excrement of the pet falls into the storage space through the first opening and the second opening.

4. The pet toilet device as claimed in claim 1, wherein the monitoring device defines a center of gravity stability frame by expanding outward from the center of gravity position.

5. The pet toilet device as claimed in claim 1, wherein the monitoring device generates the position of the center of gravity according to the weight values and the positions of the load cells arranged on the upper surface of the storage space.

6. The pet toilet device as claimed in claim 1, wherein when an updated position of the center of gravity touches an edge of the center of gravity stability frame, the monitoring device further moves the center of gravity stability frame according to a moving direction of the updated position of the center of gravity.

7. The pet toilet device as claimed in claim 1, wherein when the duration is greater than a threshold value, the monitoring device determines that the pet is in the defecation state.

8. The pet toilet device as claimed in claim 1, wherein when the duration is greater than a threshold value, the monitoring device further starts a cleaning program to clean the pet toilet device.

9. A pet defecation determination method, comprising:
calculating a center of gravity position of a pet based on weight values measured at a plurality of sensor positions on a pet toilet device;
forming a center of gravity stability frame based on a distance outward from the position of the center of gravity;
determining whether an updated position of the center of gravity of the pet touches an edge of the center of gravity stability frame;
starting to calculate a duration of the updated position of the center of gravity of the pet in the center of gravity stability frame when the updated position of the center of gravity of the pet does not touch the edge of the center of gravity stability frame;
comparing the duration with a threshold value; and
determining that the pet is in a defecation state when the duration is greater than the threshold value.

10. The pet defecation determination method as claimed in claim 9, further comprising moving the center of gravity stability frame according to a moving direction of the updated position of the center of gravity of the pet when the updated position of the center of gravity of the pet touches the edge of the center of gravity stability frame.

11. The pet defecation determination method as claimed in claim 9, further comprising starting a cleaning program to clean the pet toilet device when the duration is greater than the threshold value.

12. The pet defecation determination method as claimed in claim 9, further comprising using a plurality of load cells, which are arranged at predetermined positions on the pet toilet device, to measure the weight values applied by the pet.

13. The pet defecation determination method as claimed in claim 12, further comprising calculating the position of the center of gravity of the pet based on the measured weight values and the corresponding spatial positions of the plurality of load cells.

14. The pet defecation determination method as claimed in claim 12, further comprising setting an idle state time threshold value.

15. The pet defecation determination method as claimed in claim 14, further comprising calculating a duration during which the pet is absent from the pet toilet device.

16. The pet defecation determination method as claimed in claim 15, further comprising controlling the load cells to execute a zeroing procedure when the calculated duration exceeds the idle state time threshold value.
